(19) United States
(12) Patent Application Publication
(10) Pub. No.: US 2009/0115973 A1
(43) Pub. Date: May 7, 2009

(54) DETECTING SYSTEM AND METHOD FOR COLOR WHEEL

(75) Inventor: YU-LUN HO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/125,878

(22) Filed: May 22, 2008

(30) Foreign Application Priority Data
Nov. 5, 2007 (CN) 200710202391.5

(51) Int. Cl. G03B 21/14

(52) U.S. Cl. 353/84

(57) ABSTRACT

A detecting system includes a light source, a dichroic prism, a light sensing unit, a processing unit, and a display device. The light source is configured for emitting light to color segments of a color wheel to be checked to generate separated color lights in a sequence according to that of the color segments of the color wheel. The dichroic prism is configured for receiving the sequenced color lights and transmitting the color lights therefrom. The light sensing unit is configured for detecting the sequenced color lights transmitted from the dichroic prism and generate corresponding signals. The processing unit is configured for receiving the signals from the sensing unit, and interpreting the signals as displayable sequence information of the color segments. The display device is configured for displaying the sequence information.

### BACKGROUND

1. Field of the Invention

The present invention relates to a detecting system and method for color wheels, and particularly, to a detecting system and a detecting method for checking order of filter segments within a color wheel.

2. Description of the Related Art

Generally, a projection device, such as a digital light processing projector, uses a color wheel to separate white light from a light source into colored lights, in which a desired color is properly displayed on a screen only when color segments of the color wheel are arranged in a predetermined order. If the color segments are out of order, the color of the image on the screen is incorrectly presented. Therefore, a process for detecting whether the order of the color segments is correct is called for before the color wheel leaves factory. This process is conventionally carried out by visual inspection, which is an inefficient use of manpower and resources.

Therefore, it is desirable to provide a detecting system and method for a color wheel, which can overcome the above mentioned problem.

### SUMMARY

A detecting system includes a light source, a dichroic prism, a light sensing unit, a processing unit, and a display device. The light source is configured for emitting light to color segments of a color wheel to be checked to generate separated colored lights in a sequence according to that of the color segments of the color wheel. The dichroic prism is configured for receiving the sequenced colored lights and transmitting the colored lights therefrom. The light sensing unit is configured for detecting the sequenced colored lights transmitted from the dichroic prism and generating corresponding signals. The processing unit is configured for receiving the signals from the sensing unit, and interpreting the signals as displayable sequence information of the color segments. The display device is configured for displaying the sequence information.

### BRIEF DESCRIPTION OF THE DRAWINGS

Many aspects of the present detecting system and method can be better understood with reference to the following drawings. The components in the drawings are not necessarily drawn to scale, the emphasis instead being placed upon clearly illustrating the principles of the present detecting system and method. Moreover, in the drawings, like reference numerals designate corresponding parts throughout the several views.

FIG. 1 is a schematic view of a detecting system for a color wheel, according to an exemplary embodiment.

FIG. 2 is a schematic view of the color wheel of FIG. 1.

FIG. 3 is a flow chart of a detecting method for checking segment sequence of the color wheel, according to another embodiment.

### DETAILED DESCRIPTION

Embodiments of the present system and method will be described in detail below with reference to the drawings.

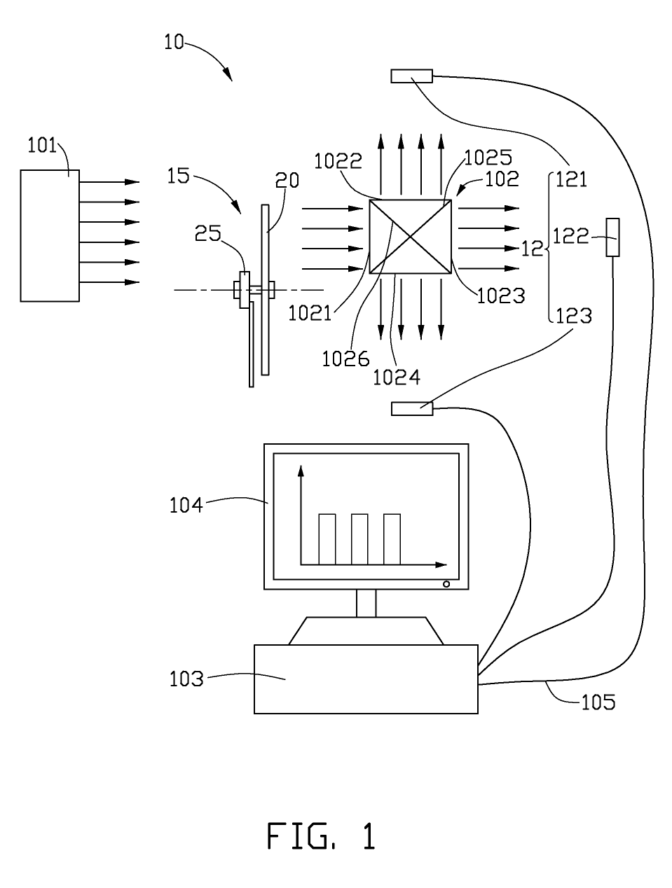

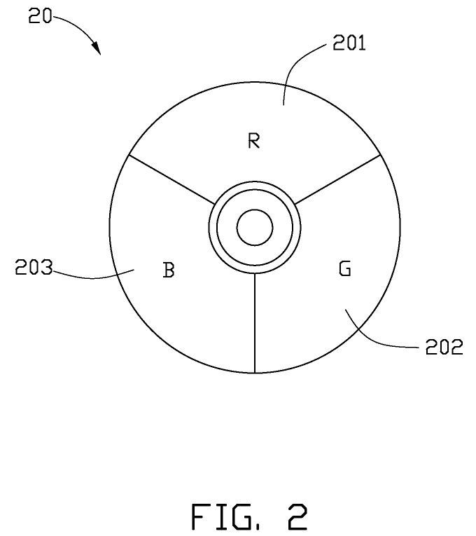

Referring to FIG. 1 and FIG. 2, a detecting system 100 for a color wheel 110 is shown. The color wheel 110 has color segments arranged in a specific sequence. The detecting system 100 includes a light source 120, a dichroic prism 130, a light sensing unit 140, a processing unit 150, and a display device 160. The light source 120 is configured for emitting white light to the color wheel 110. The white light is then separated into colored lights in a specific sequence according to the sequence of the color segments of the color wheel 110. The color wheel 110 and the dichroic prism 130 are positioned in the path of the emitted light. The light sensing unit 140 is connected to the processing unit 150 and the display device 160, and is configured for detecting the sequenced colored lights separated by the color wheel 110 through the dichroic prism 130 and generating electrical signals.

The color wheel 110, for example, has three color segments: red (R) 111, green (G) 112, and blue (B) 113 (shown in FIG. 2) symmetrically arranged in a predetermined sequence to separate the white light emitted from the light source 120 into RGB colored lights in the predetermined sequence. In other embodiments, the color wheel 110 may have more than three color segments.

The light source 120 includes a lamp, such as a metal halide lamp, to emit the white light.

The dichroic prism 130, such as an X-cube, includes an incident surface 131, and three emitting surfaces 132-134, and is structured such that the incident surface 131 is configured for receiving consecutive colored lights from the color wheel 120. The emitting surfaces 132-134 are configured for respectively transmitting the corresponding colored lights.

The light sensing unit 140 includes a first light sensing device 141, a second light sensing device 142, and a third light sensing device 143, which are arranged so as to respectively detect the colored lights transmitted from the emitting surfaces 132-134 of the dichroic prism 130, and are configured for generating an electrical signal, such as a voltage pulse, respectively. In the embodiment, the light sensing unit 140 can be a charge-coupled device.

The processing unit 150 is configured to receive the electrical signals from the first, second, third light sensing devices 141-143 of the light sensing unit 140, respectively, and thereby interprets the received electrical signals as displayable sequence information associated with the arranged sequence of the color segments 111-113 of the color wheel 110.

The display device 160 is configured for displaying the sequence information of the color segments 111-113 for inspectors.

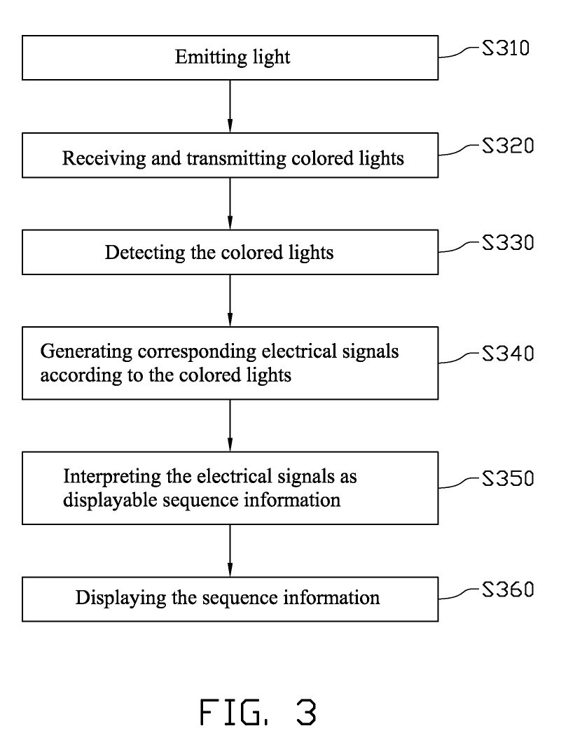

Referring to FIG. 3, a detecting method for detecting the sequence information of the color segments 111-113 of the color wheel 110 includes the following operations S310-S360.
S310: Emitting light. The light source 120 is used to emit light to the color segments 111-113 of the color wheel 110 to be separated into colored lights in a special sequence.
S320: Receiving and transmitting the colored lights by the dichroic prism 130.
S330: Detecting the colored lights transmitted from the emitting surfaces 132-134 of the dichroic prism 130 by the corresponding light sensing devices 141-143.
S340: Generating corresponding electrical signals according to the colored lights by the corresponding light sensing devices 141-143.
S350: Interpreting the electrical signals as displayable sequence information of the color segments 111-113 of the color wheel 110.
S360: Displaying the sequence information of the color wheel 110 by the display device 160.

In the method shown in FIG. 3, Step S310 may be accomplished by a light source generating the light for emission to the color wheel to be detected to generate the separated colored lights in the special sequence. The light may be emitted to the color wheel to be separated by the color segments of the color wheel to generate the separated colored lights in the special sequence (S310). Receiving and transmitting the separated colored lights (S320) may be accomplished by a dichroic prism receiving and transmitting the colored lights. Detecting the separated colored lights (S330) may be accomplished by a light sensing unit detecting the separated colored lights. The separated colored lights may be detected by three light sensing devices of the light sensing unit, each of which may be charge-coupled devices of the light sensing unit. The corresponding electrical signals may be generated according to the separated colored lights by the light sensing unit (S340). The displayable sequence information may be displayed by a display device (S360).

Compared with the related art, the present detecting system 100 provides a correct inspection, thereby enhancing efficiency and producing the correct image.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A detecting system for a color wheel, the color wheel comprising color segments configured for separating colored lights and arranged in a specific sequence, the detecting system comprising:
a light source configured for emitting light to the color wheel to be detected to generate separated colored lights in a specific sequence according to that of the color segments of the color wheel;
a dichroic prism configured for receiving the sequent colored lights, and transmitting the colored lights therefrom;
a light sensing unit configured for detecting the sequent color lights transmitted from the dichroic prism and thereby generating corresponding electrical signals;
a processing unit configured for receiving the electrical signals from the sensing unit, and interpreting the signals as displayable sequence information of the color segments of the color wheel;
a display device configured for displaying the sequence information.

2. The detecting system as claimed in claim 1, wherein the dichroic prism comprises an incident surface and three emitting surfaces, the incident surface configured for receiving consecutive colored lights from the color wheel and the emitting surfaces configured for respectively transmitting the corresponding colored lights.

3. The detecting system as claimed in claim 1, wherein the light sensing unit comprises a first light sensing device, a second light sensing device, and a third light sensing device, which are arranged so as to respectively detect the colored lights transmitted from the emitting surfaces of the dichroic prism and are configured for generating an electrical signal such as a voltage pulse respectively.

4. The detecting system as claimed in claim 1, wherein the color segments are composed of a red segment, a blue segment, and a green segment.

5. The detecting system as claimed in claim 1, wherein the light sensing devices are charge-coupled devices.

6. A method for detecting sequence of color segments of a color wheel, the method comprising:
emitting light to the color wheel to be detected to generate separated colored lights in a special sequence;
receiving and transmitting the separated colored lights;
detecting the separated colored lights;
generating corresponding electrical signals according to the separated colored lights;
interpreting the electrical signals as displayable sequence information; and
displaying the displayable sequence information.

7. The method as claimed in claim 6, wherein emitting the light to the color wheel to be detected to generate the separated colored lights in the special sequence is a light source generating the light for emission to the color wheel to be detected to generate the separated colored lights in the special sequence.

8. The method as claimed in claim 6, wherein emitting the light to the color wheel to be detected to generate the separated colored lights in the special sequence is emitting the light to the color wheel to be separated by the color segments of the color wheel to generate the separated colored lights in the special sequence.

9. The method as claimed in claim 6, wherein receiving and transmitting the separated colored lights is a dichroic prism receiving and transmitting the colored lights.

10. The method as claimed in claim 6, wherein detecting the separated colored lights is a light sensing unit detecting the separated colored lights.

11. The method as claimed in claim 10, wherein generating the corresponding electrical signals according to the separated colored lights is the light sensing unit generating the corresponding electrical signals according to the separated colored lights.

12. The method as claimed in claim 10, wherein detecting the separated colored lights is three light sensing devices of the light sensing unit detecting the separated colored lights.

13. The method as claimed in claim 12, wherein detecting the separated colored lights is charge coupled devices of the light sensing unit detecting the separated colored lights.

14. The method as claimed in claim 6, wherein displaying the displayable sequence information is a display device displaying the displayable sequence information.
